(19) United States
(12) Patent Application Publication
(10) Pub. No.: US 2012/0310745 A1
(43) Pub. Date: Dec. 6, 2012

(54) SYSTEM FOR MANAGING ADVERTISEMENTS AND PROMOTIONS

(75) Inventors: Tarun Bhatia, Burbank, CA (US); Ayman Farahat, Santa Clara, CA (US)

(73) Assignee: Yahoo! Inc., Sunnyvale, CA (US)

(21) Appl. No.: 13/149,453

(22) Filed: May 31, 2011

(51) Int. Cl. G06Q 30/00

(52) U.S. Cl. 705/14.66

(57) ABSTRACT

A computer-implemented method of marketing includes identifying an opportunity to serve an advertisement or a promotion to a user. Information about the user is gathered. Through the use of at least one processor, an expected responsiveness of the user to advertisements is determined based on the gathered information. Through the use of the at least one processor, an expected responsiveness of the user to promotions is also determined based on the gathered information. The advertisement or the promotion is provided to the user based on the determined expected responsiveness of the user to advertisements and the determined expected responsiveness of the user to promotions.

### TECHNICAL FIELD

The present description relates generally to a system and method, generally referred to as a system, for managing advertisements and promotions.

### BACKGROUND

Advertisers are constantly striving to reach out to their audience through a careful balance of short-term promotions and long-term branding and building of consumer good will. Short-term promotions, such as coupons, may be intended to drive immediate sales, help clear inventory, or retain consumers. Long-term advertising may be intended to build equity in a brand and earn consumer loyalty.

### SUMMARY

A computer-implemented method of marketing includes identifying an opportunity to serve an advertisement or a promotion to a user. Information about the user is gathered. Through the use of at least one processor, an expected responsiveness of the user to advertisements is determined based on the gathered information. Through the use of the at least one processor, an expected responsiveness of the user to promotions is also determined based on the gathered information. The advertisement or the promotion is provided to the user based on the determined expected responsiveness of the user to advertisements and the determined expected responsiveness of the user to promotions.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for managing advertising campaigns and/or distributing advertisements and promotions.

FIG. 2 is a block diagram of an advertising system for managing advertising campaigns and/or distributing advertisements and promotions.

FIG. 3 is a block diagram of a network for managing advertising campaigns and/or distributing advertisements and promotions.

FIG. 4 is a block diagram of a network for managing advertising campaigns and/or distributing advertisements and promotions.

FIG. 5 is a block diagram of a portion of an advertising system for managing advertising campaigns and/or distributing advertisements and promotions.

FIG. 6 is a diagram of a method for distributing advertisements and promotions.

FIG. 7 is a flow diagram of a method for distributing advertisements and promotions.

FIG. 8 is a flow diagram of a method for distributing advertisements and promotions.

FIG. 9 is a processing system for use with managing advertising campaigns and/or distributing advertisements and promotions.

### DETAILED DESCRIPTION

Advertisements and promotions are ways to promote awareness of services and products to consumers. The advertisements and promotions may be allocated selectively, based on characteristics of the user or typical users of the particular web page. In addition or alternatively, the advertisements and promotions may be selected to match or relate to user and content information, location, timing, user propensity, expected user response, and other criteria to advertiser specifications, for targeting the ads to potential consumers. It may be important to ensure that various types of advertisements and promotions or coupons are targeted to users most likely to be responsive to the advertisement type.

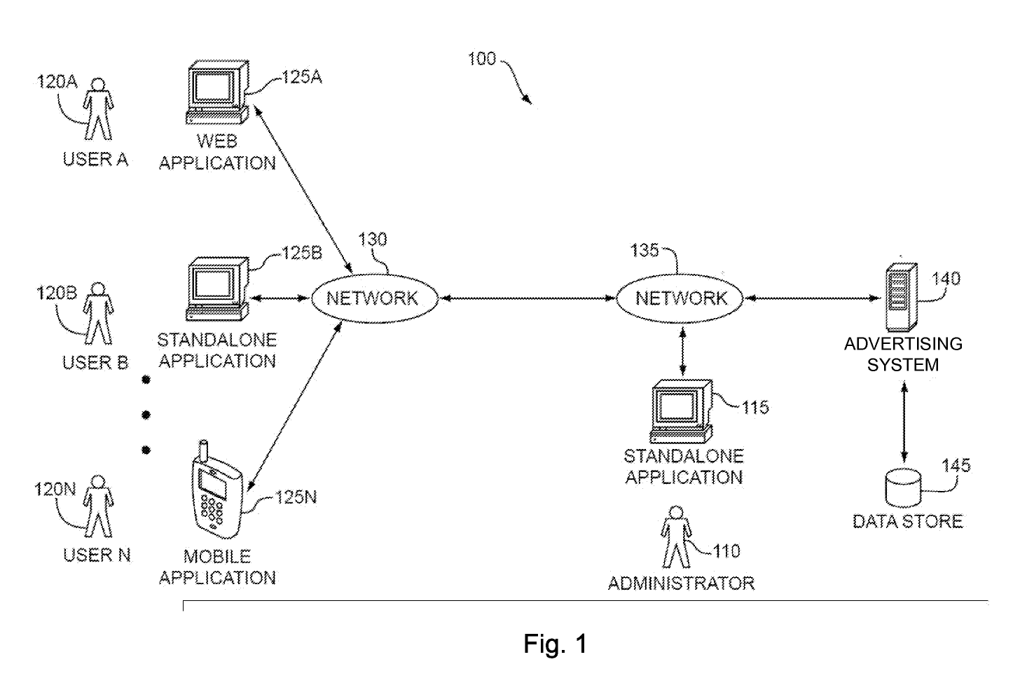

FIG. 1 provides a simplified view of a network environment 100 for marketing and/or managing promotions and serving advertisements or advertisement impressions and promotions in an optimized way. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 100 may include an administrator 110 and one or more users 120A-120N with access to one or more networks 130, 135, and one or more web applications, standalone applications, mobile applications 115, 125A-125N, which may collectively be referred to as client applications. The network environment 100 may also include one or more advertising systems 140, which may be advertising servers, and related data stores 145. The users 120A-120N may request pages, such as web pages, via the web application, standalone application, mobile application 125A-125N, such as web browsers. The requested page may request an advertisement impression or promotion from the advertising system 140 to fill a space on the page. The advertising system 140 may serve one or more advertisement impressions or promotions to the pages. The advertisement impressions or promotions may include online graphical advertisements or promotions, such as in a unified marketplace for graphical advertisement impressions or promotions. Information about projected supply may be determined with a model that may be created, modified, and/or used by the advertising system 140. Some or all of the advertising system 140 and the one or more web applications, standalone application, mobile applications 115, 125A-125N, may be in communication with each other by way of the networks 130 and 135.

The networks 130, 135 may include wide area networks (WAN), such as the Internet, local area networks (LAN), campus area networks, metropolitan area networks, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-125N may be connected to the network 130 in any configuration that supports data transfer. This may include a data connection to the network 130 that may be wired or wireless. Any of the web applications, standalone applications and mobile applications 115, 125A-125N may individually be referred to as a client application.

The web application 125A may run on any platform that supports web content, such as a web browser or a computer, a mobile phone, personal digital assistant (PDA), pager, tablet, notebook, network-enabled television, digital video recorder, such as TIVO®, automobile and/or any appliance or platform capable of data communications.

The standalone application 125B may run on a machine that includes a processor, memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement system 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE®.

The advertising system 140 may exist on one machine or may be running in a distributed configuration on one or more machines. The advertising system 140 may be in communication with the client applications 115, 125A-125N, such as over the networks 130, 135. For example, the advertising system 140 may provide an interface to the users 120A-120N through the client applications 125A-125N, such as a user interface for inputting search requests and/or viewing web pages. Alternatively or in addition, the advertisement system 140 may provide a user interface to the administrator 110 via the client application 115, such as a user interface for managing the data source 145 and/or configuring advertisements.

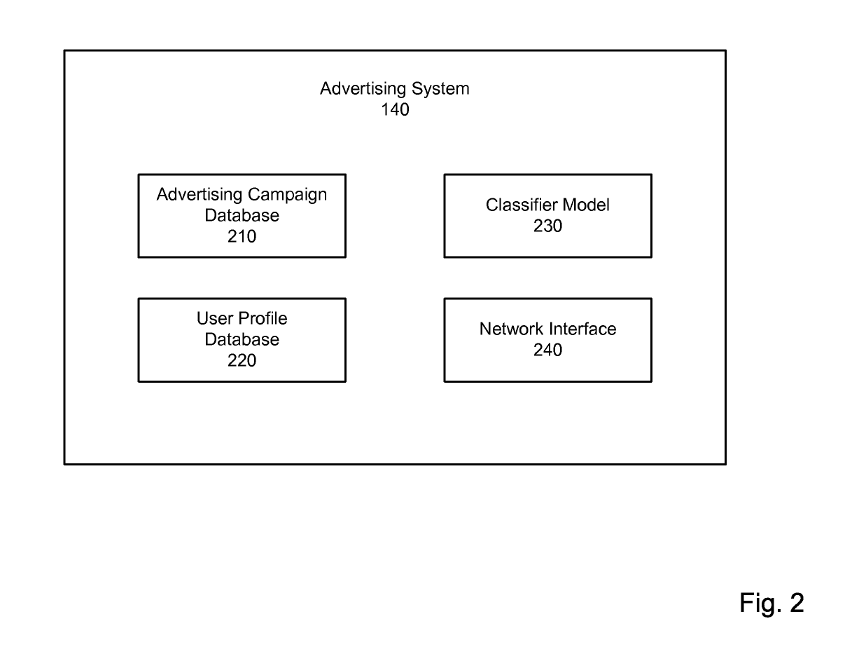

FIG. 2 is a block diagram of an example advertising system 140. The advertising system 140 may include one or more of an advertising campaign database 210, a user profile database 220, a classifier model 230, and/or a network interface 240. More or less components may be provided in other examples. Each of these components may be connected and/or interact with each other in various ways. In some systems, one or more of these components may be separate and/or distinct from the advertising system 140. For example, in some systems, the advertising campaign database 210 and/or the user profile database 220 may be included in and/or accessed from the data store 145. The advertising system 140 may also be referred to as a marketing system. Various other configurations are possible.

The advertising campaign database 210 may store one or more advertising campaigns. An advertising campaign (also referred to as “ad campaign”) may be, include, arrange for, and/or otherwise identify information and/or data related to advertising and/or promotional efforts of an advertiser, such as advertiser 410 described later, with an online provider, such as an online provider 330 described later. The advertising campaign may include and/or specify various data, parameters, and/or information about the distribution and/or logistics of advertisements and/or promotions for an advertiser. For example, an advertising campaign may include information and/or data about how much an advertiser will spend to advertise and/or promote the advertiser's services, what types of media the advertiser will advertise and/or promote on, content and/or types of digital and/or web pages an advertiser will advertise and/or promote on, what kinds of advertisements and/or promotions an advertiser will use, how often an advertiser wishes to display an advertisement and/or promotion, to what kind of user an advertiser wishes to display an advertisement and/or promotion, and/or various other information and/or data about an advertiser, advertisement and/or promotion for the advertiser, and/or users to view the advertiser's advertisement and/or promotion. The advertising campaign may include information and/or data about a goal or objective for an advertiser. For example, an advertising campaign may specify and/or identify that a goal of the advertiser may be to clear inventory and/or promote a new line of products.

The advertisement campaigns may be used to organize an advertiser's advertisements, and may specify and/or designate to whom, when, where, and how an advertisement will be displayed, as well as what advertisement will be displayed. An advertiser may wish to set up or book ad campaigns with one or more advertisement systems, service providers, web publishers, or otherwise, in order to selectively consume available ad opportunities. Ad campaigns may specify matching attributes or values for a subset of attributes of ad opportunities or ad impressions that the ad campaigns target.

The advertising campaign may include information about an advertiser's marketing history, efforts, ideas, and/or goals. The advertising campaign may include one or more advertisements and/or promotions. Advertisements and/or promotions may be displayed online, such as with variable banner ads inserted into web pages that are transmitted to users. Alternatively and/or in addition, an advertisement, advertiser listing, and/or promotion may be inserted into a list of results returned in response to a user search query. Alternatively and/or in addition, for example, an advertisement, advertiser listing, and/or promotion may be inserted when a user is playing a game on a web site, a mobile phone, or a smart phone. Alternatively and/or in addition, an advertisement, advertiser listing, and/or promotion may be inserted when a user is using an application on a web site, on a mobile phone, or on a smart phone. Ad opportunities may provide an opportunity for an advertisement and/or promotion to be delivered to a user, and may arise anytime a user visits a page, enters a search query, plays a game on a website or phone, uses an application on a website or phone, or uses a search engine. For example, every web site view may be an ad opportunity.

An advertisement may be distinguishable from a promotion, coupon, or deal (“promotion”). In some systems, either an advertisement or a promotion may be interchangeably used to fill an advertising opportunity. However, there may be differing motives for choosing an advertisement versus a promotion. Such motives may range, such as along one or more spectrums, from a desire for pure brand awareness and brand equity building through performance seeking advertisements that prompt a user to visit a site, register, click through, review or consider; to deals, coupons, or promotions that may monetarily incentivize, persuade or entice specific actions to be performed by a user in a short term and/or under specific conditions or deal terms, such as persuading a user to try a product or service. In some systems, the motives may lie somewhere in between or along one or more spectrums.

An advertisement may be presented to promote an advertiser's brand, create brand awareness, enforce a slogan or idea associated with a brand or advertiser, and/or to promote goods or services of the advertiser intended to be sold at a full price. For example, an advertisement may generally promote a restaurant chain or a soda brand, with a purpose of creating brand awareness and reinforcing a slogan or idea that the viewer “Eat Here” or “Drink This.” A goal of and/or achieved by an advertisement may be to promote a long-term awareness and/or goodwill of an advertiser and/or brand. Various advertisements are possible.

A promotion may promote an advertiser's brand and/or may promote good or serves of the advertiser. A promotion may differ from a standard advertisement in that a promotion may promote selling a good or service of the advertiser at a discount, and/or providing a deal or coupon of some kind to a user. A promotion may offer a deal to a user, and/or may spoil a user. A goal of and/or achieved by a promotion may be to clear an inventory, attempt to get a new market or new consumers, and/or to entice users who otherwise would not be interested in an advertiser to consider the advertiser, and may be based on a deal provided by the advertiser. For example, an advertiser may wish to clear a seasonal inventory, such as a fall collection of clothes, in order to make room for a new inventory, such as a spring collection. The advertiser may run a promotion to inform consumers of a sale price or coupon to purchase remaining items from the fall inventory at a discounted price to clear space. Various other promotions are possible.

The advertisements and/or promotions may, for example, be created by an advertiser, an online provider, and/or various other entities. An advertiser may include or specify during the creation of an advertising campaign how many advertisements and/or promotions are to be displayed and/or to whom they are to be displayed, or the advertiser may leave such determinations to the discretion and/or determination of the online provider. The advertising campaign may or may not be created by an advertiser. Various other data and/or pieces of information may be included in an advertising campaign.

The advertising campaign database 210 may store information and/or data about one or more advertising campaigns. For example, the advertising campaign database 210 may store information and/or data about one or more advertising campaigns managed and/or operated by an online provider. In some systems, the advertising campaign database 210 may store all information about advertising campaigns managed and/or operated by an online provider.

The advertising campaign and/or information about the advertising campaign may be used by another entity, such as an online provider, to manage and/or operate the advertising and/or promotional efforts of the advertiser. For example, an online provider may manage and/or operate an advertiser's digital advertisement and/or promotion display using the information and/or data in the advertising campaign. Various other examples are possible.

The user profile database 220 of the advertising system 140 may include information and/or data about one or more users, such as users 120A-120N. The user profile database 220 may include information such as user data 550 describe later. The user profile database 220 may include raw data, processed data, and/or a created and/or generated user profile about one or more of the users 120A-120N. The user profile database 220 may or may not be used by the advertising system 140, such as with the classifier model 230, to determine who to serve with advertisements and/or promotions, as described later. Various other information and/or data may be stored in the user profile database 220.

Indiscriminately showing advertisements and promotions to a user may be costly and inefficient. Information and/or data (“information”) about a propensity of a user to respond to promotions and deals, information and/or data about a user's propensity to respond to advertisements and pay full price for a good or service, and/or an estimated and/or calculated long term effect and/or goodwill of an advertisement may be useful in determining whether to serve an advertisement or a promotion to a user. Part or all of this information may be used, for example, by a classifier model 230.

The classifier model 230 of the advertising system 140 may perform various functions. The classifier model 230 may be, include, incorporate, and/or use algorithms such as classification algorithms, historical data, modeling, and/or various other techniques to process and/or analyze data input into the classifier model 230. The algorithms may be or include a machine learning algorithm or various other algorithms. Historical data and/or data about trajectories of users and may be used by the classifier model 230. Various other techniques may be used.

In some systems, user data and/or user profiles stored in the user profile database 220 may be input into the classifier model 230. The classifier model 230 may compute or categorize one or more users through processing and/or analysis of the user data and/or user profiles about the users stored in the user profile database 220. The classifier model 230 may subdivide, classify, and/or categorize one or more users into various categories, such as categories related to spending habits and/or expected response to advertisements or promotions. Some or all users in contact with an advertising system 140, and/or an online provider, may be scored, ranked, and/or classified into one or more categories by the classifier model 230. For example, the classifier model 230 may compute or determine users which may be likely to be responsive to advertisements and users which may be likely to be responsive to promotions. The classifier model 230 may calculate, compute, and/or determine a distribution of one or more users 310 and/or related to one or more categories, variables, and/or topics.

Analysis, scoring, classifications, rankings, and/or other determinations and/or processes performed by the classifier model 230 may be done using one or more pieces of information. For example, in some systems, the classifier model 230 may classify all users using three pieces of information about the user: a frequency of purchase, a quantity purchased, and a price paid for the purchase compared to a suggested retail price. The classifier model 230 may compute attributes, rankings, scores, distribution and/or percentages related to a frequency a user makes purchases relative to other users. The classifier model 230 may compute attributes, rankings, scores, distribution and/or percentages related to a quantity of products or services purchased by a user relative to other users. The classifier model 230 may compute attributes, rankings, scores, distribution and/or percentages of prices users pay relative to a retail price, such as a manufacturer's suggested retail price. Various other examples are possible.

The classifier model 230 may use this or other data to calculate one or more distribution of users. In some systems, the classifier model 230 may calculate and/or determine a distribution of users and/or assign each user one or more attributes, rankings, scores, and/or percentages indicating a position of a user and/or confidence in applying a characterization to a user. The characterizations may, for example, include a user's profitability to show a promotion or advertisement to, a user's favorable response to and/or propensity for promotions or advertisements, user's purchases relative to the norm, user's purchase price generally paid relative to a manufacturer's suggested retail price, user's propensity to make purchases on impulses, user's propensity to buy when no deal is present, and/or various other categorizations. For example, the classifier model 230 may identify a user A as being in the 85^{th} percentile for shopping frequency, in the 10^{th} percentile for quantity purchased, and/or averaging a payment of 93% of the manufacturer's suggested retail price. In some systems, each user 310 may have a vector of features identifying a consumption pattern of the user 310. Various other examples are possible.

The classifier model 230 may also or alternatively classify one or more users into one or more groups. Classification may be done based on raw data and/or based on calculated distributions. Classified groups may include, for example, users that are profitable to show a promotion to, users that a profitable to show an advertisement to, an expected profitability of a promotion served to a user, an expected profitability of an advertisement served to the user, users that response favorably to and/or have a propensity for promotions, users that respond favorably to and/or have a propensity for advertisements, users who make more purchases relative to the norm, users who make less purchases relative to the norm, users whose purchase price generally paid relative to a manufacturer's suggested retail price is greater or less than the norm, users who make purchases on impulses, users who never make purchases on impulses, users who buy infrequently when no deal is present, users who often buy when no deal is present, and/or various other categories.

The classifier model 230 may, for example, classify users who buy frequently, buy in large quantities, and frequently pay full price as users that may be responsive to advertisements. Users like this may be served best with advertisements for a brand and/or promoting a new seasonal line of clothing, for example, as these users may be willing to purchase a good or service for full price and without a discount. Users like this may not be good targets for promotions unless an advertiser is merely trying to clear space, as these users may normally be willing to purchase a good or service for full price, and therefore a promotion may merely reduce revenue possibilities for the advertiser. The classifier model 230 may, for example, classify users who buy frequently, buy in moderate quantities, and always purchase on discounts or using coupons as users that may be responsive to promotions. Users like this may be best served with promotions, but may not be responsive to advertisements for a brand and/or promoting a new seasonal line of clothing, for example, as these users may not be willing to purchase a good or service for full price and without a discount. Various other examples are possible.

In some systems, not enough data may be available about a user 310 to definitively classify the user 310 and/or compute a distribution for the user 310. In some of these systems, the advertising system 140 may provide the user 310 with both advertisements and/or promotions at various advertising opportunities that arise for the user 310, and gather data about the user's response to the advertisements and/or promotions. After gathering data about the user 310, the advertising system 140 may then make a classification of the user 310, such as using the classifier model 230. In some systems, the more data collected about a user 310, the more certain the classifier model 230 may be that a user 310 may fit into a classification and/or distribution determined by the classifier model 230.

The classifier model 230 may be constructed from data and/or information received. For example, the classifier model 230 may be a dynamic model which may be constructed from observational data and/or augmented as new data is received. In some systems, the classifier model 230 may processes any and all information about a given user. The classifier model 230 may assign a given user one or more scores, such as a propensity score, that may indicate whether it is more favorable to show the user an ad or a promotion. In some systems, the propensity score may also be based on the user's propensity based on a particular context or advertising opportunity. For example, a user may have multiple scores assigned, such as a score for an advertising opportunity on a sports web page, or a score for a situation where an advertiser is looking to sell a lot of inventory fast at a very reduced price. Other variations are possible.

The advertising system 140 may include a network interface 240. The network interface 240 may be, represent, and/or include an interface and/or connection between the advertising system 140, the networks 130 and 135, and/or one or more users 120A-120N. For example, a user 120A may access information and/or data provided by an operator of the advertising system 140, such as an online provider, through and/or using the network interface 240. Information about the user 120A and/or the user's interaction with the advertising system 140 and/or the operator of the advertising system may be gathered through and/or using the network interface 240. The advertising system 140 and/or an operator of the advertising system 140 may transmit, send, and/or otherwise output data and/or information to the user 120A through the network interface 240, such as, for example, content, advertisements, and/or promotions. Various other examples are possible.

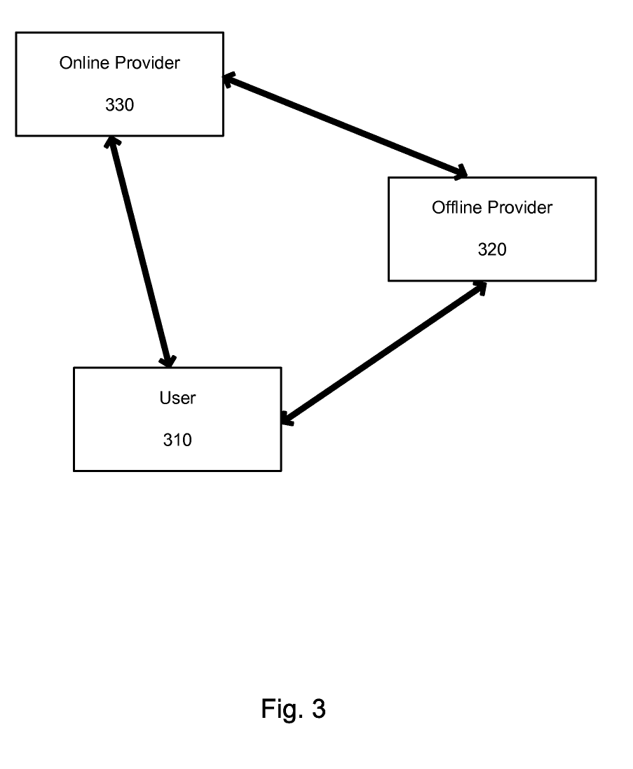

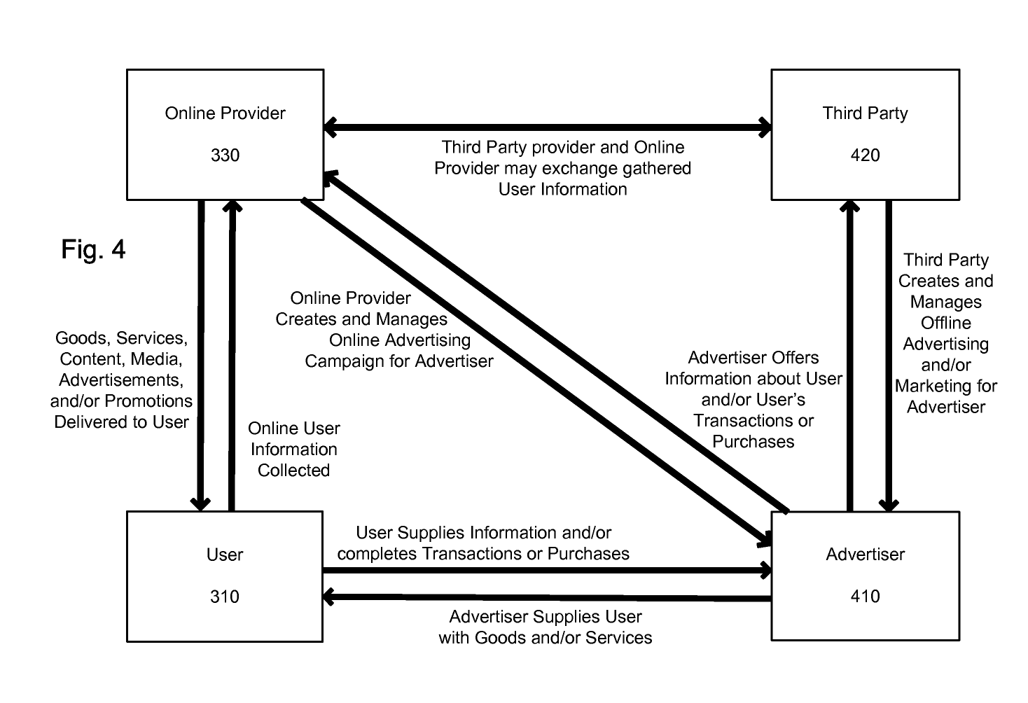

FIG. 3 is a block diagram which shows an example of a user 310, an offline provider 320, and an online provider 330, and illustrates how the three may interact and/or communicate with each other. FIG. 4 is a block diagram which shows an example a user 310, an online provider 330, an advertiser 410, and a third party 420, and illustrates how the four may interact and/or communicate with each other.

A user 310 may be a consumer, an advertiser, a business, an individual, a group, and/or various other entities. A user 310 may be any other entity that may interact with an offline provider 320 and/or an online provider 330. For example, a user 310 may be a consumer who frequently engages in shopping both online and at a mall. Alternatively, a user 310 may be a small business or large corporation. In some systems, a user 310 may be any of the users 120A-N or the administrator 110. Various other users 310 are possible.

An offline provider 320 may be a business or advertiser, such as advertiser 410, a third party or third party provider, such as third party 420, a service provider, an entity that collects information about a user, and/or an entity that provides a good or service to a user or another entity. An offline provider 320 may have online resources, such as a webpage and/or digital media services. In some systems, an offline provider 320, such as a business or advertiser 410, may provide a good or service to a user 310 in person, offline, and/or online through a different portal or module than the online provider 330. An offline provider 320 may, for example, be a grocery store at which a consumer may shop for food. Alternatively, an offline provider 320 may, for example, be a restaurant or a car rental company. Alternatively, an offline provider 320 may be a third party or third party provider, such as third party 420, which may collect information about one or more users 310, such as a processing company that collects and aggregates consumption information about a user. In some systems, an offline provider 320 may be any of the users 120A-N or the administrator 110. Various other offline providers 320 are possible.

An online provider 330 may be a service provider, data provider, ad campaign provider, campaign provider, news provider, media provider, digital content provider, online services provider, email provider, web page, search engine, browser, advertiser, business, and/or an entity that provides a good, service, data, information, and/or advertisements to an entity. An online provider 330 may provider data, information, and/or advertisements to a user over and/or using a network or online connection. For example, an online provider 330 may provide advertisements to users of an online service. An online provider 330 may be or provide a search engine which may allow a user to search for information. An online provider 330 may be an online news provider or email provider. An online provider 330 may be a network provider, browser, or web page. In some systems, an online provider 330 may be any of the users 120A-N or the administrator 110. An online provider 330 may be, include, use, be in communication with, and/or otherwise access the advertising system 140. Various other online providers 330 are possible.

An advertiser 410 may be specific type of offline provider 320, or may be different. The advertiser 410 may be involved or interested in, for example, disseminating information. The advertiser 410 may wish to broadcast, advertise, and/or promote the advertiser's businesses, products, or services. The advertiser 410 may, alternatively or additionally, wish to disseminate other information about the advertiser 410 or other information. For example, the advertiser 410 may be an airport or airline and may wish to disseminate information about flights. An advertiser 410 may include any individual, group of individuals, or entity that wishes to disseminate or otherwise distribute information to another individual, group of individuals, or entities. Various other examples are possible.

A third party 420 may be a specific type of offline provider 320, or may be different. A third party 420 may, for example, be a provider who collects and/or aggregates information and data from one or more sources. In some systems, the third party 420 may be an advertising and/or promotional agency or entity which may be engaged in assisting an advertiser 410 in promoting the advertiser's business. In other systems, a third party 420 may merely be an intervening party between an online provider 330 and an advertiser 410. In other systems, the third party 420 may be a second online provider 330. In other systems, the third party 420 may be an advertiser, such as an advertiser 410. Various other third parties 420 are possible.

In some systems, a third party 420 may be helpful or necessary in order to prevent one party from disclosing confidential information about a user 310 to another party. The third party 420 in these systems may act as an intermediary. The third party 420 may gather and/or receive information from one party, such as the advertiser 410. This information may, for example, be CRM information 526 and/or other information from the advertiser, as discussed later. The third party 420 may determine parts of the information received which may not be confidential and/or which may be acceptable to be sent to another entity. The third party 420 may transmit and/or pass some or all of the received information to the second party, such as the online provider 330. The transmitted and/or passed information may be sent based on the determination of confidentiality. Any information which is not confidential and which may be useful to the online provider 330 may be sent by the third party 420.

The third party 420 may pass along raw data, such as non-confidential sales information about a user 310, or may pass along one or more processed pieces of data and/or results from any analysis performed by the third party 420. The third party 420 may interpret data from the advertiser 410 to reach an outcome about a user 310, such as reaching a determination about whether a user 310 is likely to be responsive to an advertisement or a promotion. In these systems, the third party 420 may merely pass along the determined outcome about each user 310. In some systems, the third party 420 may send one or more cookies to the online provider 330 identifying users 310. For example, the third party 420 may send cookies for all users 310 for which it may be profitable to show a promotion to.

In some systems, a third party 420 may collect one or more pieces of information from both an advertiser 410 and an online provider 330. The third party 420 may join and/or match users identified by the advertiser 410 with users identified by the online provider 330, such as with or using a custom data match or custom database matching mechanism. For example, the information from the advertisers 410 may be CRM information 526, such as an email address input by a user 310 during the creation of an account with the advertiser 410. The email address input by users may be an email address for an email account held with and/or operated by the online provider 330, and/or with other internal information 510 stored by the online provider 330. The third party 420 may match the user information from the advertiser 410 and the online provider 330 using the email address. For example, the third party 420 may use and/or incorporate consumer database matching procedures to match data received from an advertiser 410 and data received from an online provider 330. In some systems, the third party may identify a user cookie or user ID and may assign the user cookie or user ID to a targetable set, such as a targetable set derived from criteria customized for an advertiser 410 using data that may only be available with the advertiser 410. Other types of matching are possible.

The third party 420 may pass information and/or data about the user from the advertiser 410 to the online provider 330. For example, the third party 420 may generate and/or send two lists to the online provider 330, such as a list of users that will be more or most profitable when served with advertisements, and/or a list of users that will be more or most profitable when served with promotions. In some systems, only non-confidential information and/or data may be passed. In some circumstances, only relevant information and/or data may be passed. In some systems, the third party 420 may merely return cookies and/or log-in IDs for users. Various other third parties and/or functions of third parties are possible.

A user 310 may interact and/or communicate with one or more of online providers 330 and/or offline providers 320, as well as with other users. For example, a user 310 may interact with an online provider 330 and a business or advertiser 410. An online provider 330 may interact with and/or communicate with one or more of users 310 and/or offline providers 320, as well as with other online providers. For example, an online provider 330 may interact with multiple users 310, one or more advertisers 410, and/or one or more third parties 420. An offline provider 320 may interact with and/or communicate with one or more of users 310 and/or online providers 330, as well as with other offline providers. For example, an advertiser 410 may interact with a user 310, an online provider 330, and a third party 420. Various other combinations and interactions are possible.

A user 310 and an offline provider 320, such as an advertiser 410, may interact in various ways. For example, a user 310 may transact and/or purchase a good, service, content, information, and/or other items from an offline provider 320, such as an advertiser 410. In exchange for money and/or information, an advertiser 410 may supply the user 310 with goods and/or services. A user 310 may, for example, go shopping at a store run by the advertiser 410, and may purchase a good from the advertiser 410 at the store. A user 310 may, alternatively or additionally, visit an advertiser's website and transact or purchase a good, service, or content from an advertiser 410 through the advertiser's website. A user 310 may wish to make a transaction with an offline provider 320, such as open an account with an offline provider 320. Various other interactions are possible.

In some circumstances, information and/or data may be collected by the advertiser 410 about the user. For example, an advertiser 410 may collect information about IP addresses when a user 310 visits an advertiser's website. In addition or alternatively, a user 310 may volunteer some information before, during, or after participating in a transaction or purchase with the advertiser 410. For example, a user 310 may be asked for the user's email address while checking out at an electronic store, so that a product or service the user 310 bought may be registered, or so that the user 310 may receive email alerts regarding the product or service purchased. As another example, a user 310 may provide contact information and/or an email address to a service provider, such as a cleaning company, for communication purposes at the time of purchasing a service.

A user 310 may provide an offline provider 320, such as an advertiser 410, with information in other ways as well. For example, a user 310 may volunteer, sign-up, and/or register with the advertiser 410, such as to receive a club card or account, a savings card or account, regular mailings or emails such as emailed promotions, sign up for drawings or winnings, take surveys, create an account, register a product or service, and/or for various other reasons. In such circumstances, a user 310 may give information to an advertiser 410, such as a user's address, phone number, email address, other contact information, purchasing or transaction history information, income information, responses to survey and other questions posed by the advertiser 410, and/or various other types of information. In some systems, the user 310 may provide the information to receive discounts, savings, or other incentives offered by the offline provider 320 and/or advertiser 410.

A user 310 may also provide the offline provider 320 with various other data and information to the offline provider based on the transactions or purchases made by the user 310 with the offline provider 320. For example, a user's transactions and purchases may be associated with the user's account or registration at the time of a transaction or purchase, and information about the user's transactions and purchases may be collected and stored by the offline provider 320. For example, a user 310 dealing with an offline provider 320, such as a grocery store, may scan a savings card before purchasing groceries. The grocery store may store information about items purchased with the account associated with the scanned savings case.

Information collected and/or stored by an offline provider 320 may include information about a quantity, purchase price, discount, reduction in price of the purchased good, use of coupons, transaction history, and other data. Information collected and/or stored by an offline provider 320 may include personal information such as an address, social security number, email address, phone number, credit card number, personal habits such as spending habits, likes, dislikes, answers to various survey-related questions, and/or various other pieces of information.

An advertiser 410 may collect information after a registration by a user 310. For example, a user 310 may use, enable, and/or activate a club card or savings card or account every time a user 310 may shop with the advertiser 410. Information about the user's purchases or transactions, such as what is transacted, how often, at what price, and in what quantities, may then be collected, gathered, and/or tracked by the advertiser 410. Information collected by an advertiser 410 may also be or be referred to as advertiser information 520 described later, and/or may be stored and/or used to identify or describe a user, such as through a user profile stored in a user profile database 220. Other user information may be tracked using accounts, registrations, and/or other methods.

Offline providers 320 may interact in various ways with each other. For example, an advertiser 410 may interact with a third party 420. An advertiser 410 may, for example, hire a third party 420 to coordinate marketing efforts for an advertiser 410. An advertiser 410 may offer information about users and/or user's transactions or purchases to the third party 420. This may be information such as any information gathered by the advertiser 410 from users 310, as well as any other sales, promotional, or other information about the advertiser's business and/or marketing.

Information from the advertiser 410 may be offered and/or sent to the third party 420 to aid the third party 420 in creating and/or managing offline advertising and/or marketing for the advertiser 410. The third party 420 may use the information about users 310 to develop advertising campaigns, promotions, coupons, and give-away ideas for the advertiser 410 to use. For example, the third party 420 may use the information about the users 310 to print coupons specific to each user when the user 310 transacts with the advertiser 410. A user 310 may transact with the advertiser 410, and receive the coupon at the end of the transaction. The coupon may be generated based on past information about the user 310, such as the information gathered by the advertiser 410. Information and data may further be collected from the coupon, such as whether or not the user 310 used the coupon, where the user 310 used it, what other items the user bought, and/or various other transactional details.

The third party 420 may interact with various advertisers 410. The third party 420 may gather information about users 310 who have interacted with one or more of the advertisers 410, and/or may aggregate data for a user 310 who has interacted with multiple advertisers 410.

An advertiser 410 may interact with an online provider 330 in various ways. For example, as discussed herein, an advertiser 410 may wish to create and/or run an online advertising campaign. The advertiser 410 may contract with, hire, agree with, and/or otherwise work with an online provider 330 to create, develop, and run an online advertising campaign. The advertiser 410 may provide information to the online provider 330, such as information about users and/or user's transactions and/or purchases. The advertiser 410 may provide goals and/or objectives for the advertising campaign. The advertiser 410 may provide a budget for the advertising campaign. The online provider 330 may create and manage the online advertising campaign for the advertiser 410. The online provider 330 may use information provided by the advertiser 410 and/or other advertisers, one or more third parties 420, and/or one or more user 310 to create and manage the online advertising campaign for the advertiser 410. Some or all of this information collected may be stored and/or used with the user profile database 220 of the advertising system 140. Various other interactions are possible.

A user 310 and an online provider 330 may interact in various ways. An online provider 330 may provide various goods, services, content, media, and/or other information to a user 310. For example, an online provider 330 may be or may operate an email service, and a user 310 may have an email account with the online provider 330. In another example, an online provider 330 may be or may provide media or news content to a user 310. Additionally or alternatively, an online provider 330 may provide to a user 310 a portal or module for arranging and/or running a fantasy sports league, an interactive calendar, video streaming, and/or various other services or goods. In another example, an online provider 330 may be or provide an online shopping forum or website, through which a user 310 may be able to search and purchase goods or services. Various other examples are possible.

A user 310 may supply or provide information to an online provider 330. For example, an IP address or other identifier of a user 310 may be provided to, or accessed by, an online provider 330 when a user 310 accesses or otherwise interacts with content or services provided by an online provider 330. In some systems, a user 310 may volunteer information in exchange for services and/or content provided by the online provider 330. For example, a user 310 may create an account and/or register with an online provider 330, after which a user 310 may receive certain content, services, and/or benefits from the online provider 330. An example may include where a user 310 creates an account with an online provider 330 in order to participate in a fantasy sports league sponsored by the online provider 330, or in order to create and use an email account sponsored or otherwise provided by the online provider 330. A user 310 may create an account to access and/or purchase items from an online store provided by the online provider 330. This user information may be collected and/or gathered by the online provider 330.

In addition or alternative to providing various goods, services, content, and/or information, an online provider 330 may provide one or more advertisements and/or promotions to a user 310. An online provider 330 may wish to collect and use information about a user 310 to determine what type of content, advertisements, and/or promotions to serve to the user 310. Information about a user 310 may be used by the online provider 330 to determine whether to provide an advertisement or a promotion to the user 310. While some systems and methods may be described with respect to an online provider 330, it should be appreciated that these systems and methods may be applied to offline providers 320, third party providers 420, and/or advertisers 410 as well.

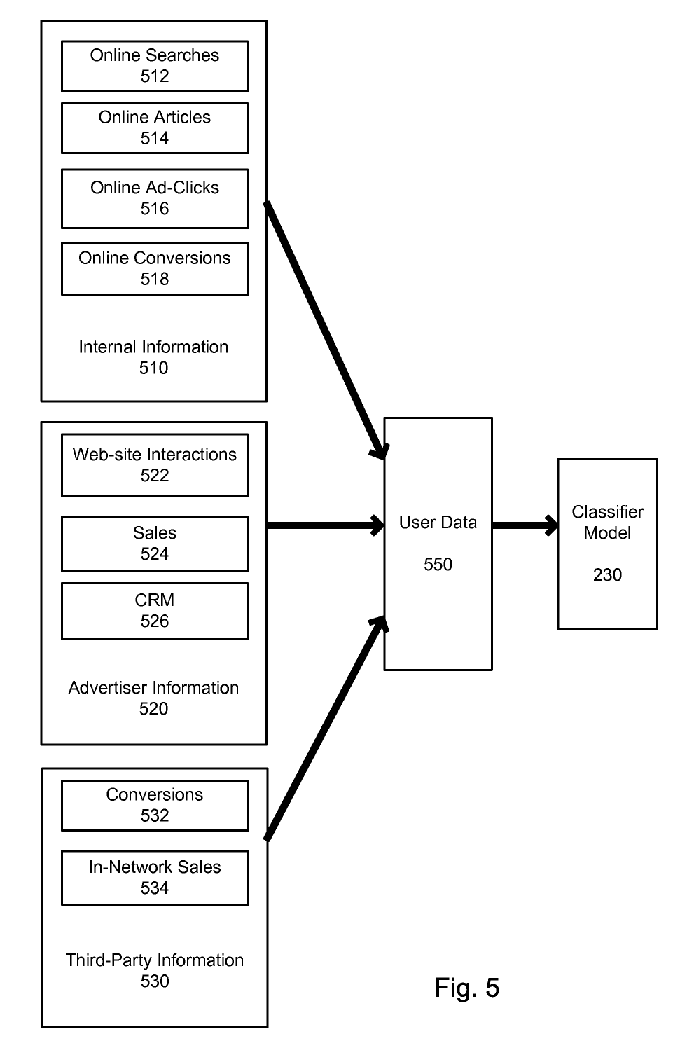

Various types of information about a user 310 may be collected by an online provider 330 from various sources. FIG. 5 illustrates some types and sources of information about user 310 which may be collected by an online provider 330. Fewer or more sources of information may be used by an online provider 330. An online provider 330 may collect information for one or a plurality of users 310. One or more pieces of information and/or data collected by an online provider 330 may be stored in, used by, or accessible to the user profile database 220 in the advertising system 140 of the online provider 330.

An online provider 330 may collect and/or gather information internally, which may be referred to as internal information 510 about the users 310. Internal information 510 about users 310 may be information which the online provider 330 may gather, collect, receive, and/or otherwise acquire from the user 310. Internal information 510 may be or may be referred to as online provider information or provider information.

The internal information 510 may include information which the user 310 provides to the online provider 330, such as information provided by a user 310 during a registration with an online provider 330. Internal information 510 about users 310 may include an IP address of the user 310. Internal information 510 about users 310 may include information about the user 310 that the online provider 330 gathers while a user 310 accesses goods, services, content, and/or information provided by the online provider 330. Internal information 510 about users 310 may include information about content or topics that a user 310 is interested in, purchases the user 310 makes, click-throughs executed by the user 310, conversions involving the user 310, and/or may provide clues and/or evidence regarding purchases a user 310 has previously made.

For example, internal information 510 about users 310 may include online searches information 512 related to online searches performed by the user 310. Online searches information 512 may include information about searches performed by the user 310 using the online provider 330, and/or searches performed by the user 310 which are otherwise accessible to the online provider 330.

Internal information 510 about users 310 may include online articles information 514 about online articles viewed and/or read by the user 310. Online articles information 514 may include information about articles viewed and/or read by the user 310 using and/or otherwise accessible to the online provider 330.

Internal information 510 about users 310 may include online ad-clicks information 516 and/or other information about user 310 interactions with online advertisements. Online advertisements that a user 310 may interact with may have been provided by the online provider 330, and interactions with these online advertisements may have been recorded by the online provider 330 as online ad-clicks information 516. Alternatively, online ad-clicks information 516 and/or other information about advertisement interaction may be otherwise accessible to the online provider 330.

Internal information 510 about users 310 may also include online conversions information 518. The online conversions information 518 may include direct information about conversions and/or purchases made by the user 310 using, or otherwise accessible to, the online provider 330. Online conversions information 518 may also include information that can be inferred from information accessible to the online provider 330 regarding conversions involving the user 310. For example, a user 310 may register online a product the user 310 purchased offline. Information about the registration may be used by the online provider 330 to infer that the user 310 bought the product being registered. Alternatively, a user 310 may utilize services of an online provider 330 to seek technical support for a product, from which the online provider 330 may infer that the user 310 purchased the product. Various other types of information may be collected internally by the online provider 330.

In addition or alternatively, an online provider 330 may gather, collect, receive, and/or otherwise acquire information about a user 310 from an advertiser 410, which may be referred to as advertiser information 520 about users 310. The advertiser 410 may have collected and/or gathered advertiser information 520 about one or more users 310, which may be useful in conducting an advertising campaign with an online provider 330. As such, the advertiser 410 may share the information with the online provider 330, such as, for example, to aid the online provider 330 in determining which users to serve advertisements and/or promotions to.

Advertiser information 520 about users 310 may include web-site interactions information 522. For example, the advertiser 410 may have a website, web page, and/or other online source through which an advertiser 410 may communicate with a user 310. The advertiser 410 may collect information in the same or a similar fashion as how the online provider 330 may collect information from a user 310 interacting with the online provider 330. This web-site interactions information 522 may include information about searches run by the user 310 on the advertiser's site or accessible to the advertiser, information about content viewed by the user 310 on the advertiser's site or otherwise accessible to the advertiser, and/or information about clicks, conversions, and/or navigation by the user 310 through the advertiser's site and/or accessible to the advertiser.

Advertiser information 520 about users 310 may include sales information 524. This sales information 524 may include information about sales that an advertiser has made to the user 310, such as sales made in person, at a store, offline, over the phone, by mail, and/or online. This sales information 524 may include information such as a frequency of purchases by the user 310, information about a quantity of items purchased by the user 310, information about a price paid and/or ratio of price paid as compared to a retail price, and/or detailed information about each individual transaction between the user 310 and the advertiser.

Advertiser information 520 may include customer (or consumer) relationship management (“CRM”) information 526. CRM information 526 may include information collected by one or more advertisers 410, such as through an account or rewards program created and/or managed by the advertisers 410. The CRM information 526 may include information associated with the account and/or program, such as personal information, spending and/or transactional information, survey information, and/or various other information and/or data about the user 310 collected by the advertiser 410.

Advertiser information 520 about users 310 may include information about the advertiser's sales to other users as well. For example, an advertiser may provide some or all of the advertiser's sale information, across some or all mediums and in some or all geographic locations, to the online provider 330. This information may aid the online provider 330 in determining which type of users may be grouped together as being responsive to advertisements and/or promotions, and/or may offer the online provider 330 with information about users that the online provider 330 may not otherwise be able to easily acquire. CRM information 526 may be or may be where an advertiser may record a full or 360 degree view of a user. CRM information 526 may include information collected by an advertiser 410 regarding online searches, site visitations, sessions, online purchases, phone-ins, third party data, offline purchases, and/or user responses to prior marketing campaigns. Various other types of information may additionally be gathered from an advertiser about one or more users.

The ability to use the CRM information 526 in determining how to serve advertisements and/or promotions to a user though an online arena may be very advantageous to an online provider 330. CRM information 526 may record details tied to users and/or interactions or transactions between a user and an advertiser. CRM information 526 may reveal or be used to identify a favorability and/or preference of a user to an advertisement or promotion under various circumstances or contexts. For example, CRM information 526 may be used to determine a user's spending habits for a specific product or a product type, such as whether or not a user buys product A when it is on sale in bulk, but not product C.

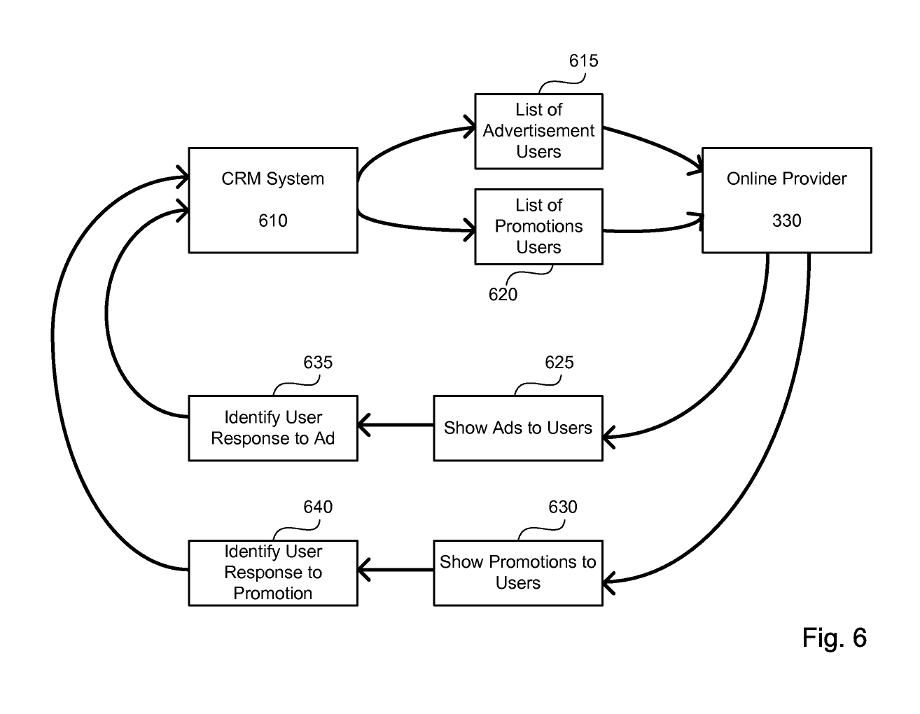

In some systems, all advertiser information 520 may be CRM information 526. In some systems, all advertiser information 520 may be stored in a CRM system or database, such as CRM system 610 shown in FIG. 6 and discussed below. Various other configurations and/or storage of advertiser information 520 is possible.

An online provider may also, or alternatively, gather information from a third party 420 about users 310, which may be referred to as third party information 530. A third party 420 may, for example, be a provider who collects and/or aggregates information and data from one or more sources, such as when working as an advertising and/or promotional agent for the advertiser 410 and/or as an intervening party between an online provider 330 and an advertiser.

Third-party information 530 about users 310 may include conversions information 532 related to the user 310, and/or in-network sales information 534 related to the user 310. For example, the third party 420 may gather all sales and/or conversion information related to the user 310 both online and in stores associated with or accessible to the third party 420. Part or all of this information may be shared with the online provider 330, or an outcome determined using this information may be passed to the online provider 330. In other systems, information and/or data from advertisers 410 and/or other third parties 420 may or may not be passed to the third party 420 for review, prior to passing any information and/or data to the online provider 330. Other information may be gathered from third parties 420.

Any internal information 510, advertiser information 520, and/or third-party information 530 may be collected by the online provider 330. Part or all of the internal information 510, advertiser information 520, and/or third-party information 530 may be grouped, represent, and/or be referred to as user data 550. User data 550 may include and/or be subdivided into one or more groups, such as into commercial user data, such as user data about transactions or purchases involving a user online or offline, as well as non-commercial data, such as user data about a number of site visits and ad exposures required to convert the user to a customer. User data 550 may include and/or be subdivided into online data about a user and offline data about a user. User data 550 may include and/or be subdivided into information about a user that results from advertising or promotions, and information about the user that does not result from or relate to advertising or promotions. Various other distinctions, subdivision, and groups are possible.

User data 550 may be, may be referred to as, and/or may be used to create one or more user profiles. The user data 550 and/or user profiles may, for example, be stored by the online provider 330, such as in the user profile database 220. Part or all of the internal information 510, the advertiser information 520, and/or the third party information 530 may be pre-collected before an opportunity may arise to serve an advertisement or a promotion to a user, and/or part or all of the internal information 510, the advertiser information 520, and/or the third party information 530 may be collected on the fly and/or at the time of the identification or determination of the existence of an opportunity. Various other configurations and methods of storage are possible.

User data 550 for one or more user 310 may be sent to and/or accessed by a classifier model 230. The classifier model 230 may use the user data 550, and/or any other data or information, such as information in the user profile database 220, to process, analyze, score, categorize, and/or otherwise identify users and user characteristics.

FIG. 6 illustrates an example of how the online provider 330, advertiser 410, CRM system 610, and/or classifier model 230 may be used to classify and/or re-classify users based on predicted user response to advertisements and/or promotions.

A CRM system 610 may be used to score and/or classify one or more users. The CRM system 610 may be operated or run by an advertiser 410, or various other entities. The CRM system 610 may store advertiser information 520. The CRM system 610 may maintain a consolidated view of the transactions associated with a customer of an advertiser 410 or other organization across many or all functions of the advertiser 410 or organization, such as service, sales, support, marketing, and various other functions. The CRM system 610 may store information about any and all interactions a user has with the advertiser 410 to maintain continuity and relevance for the user, regardless of the touchpoint. Information and/or data stored in the CRM system 610 may be gathered, stored, and/or recorded directly by advertisers 410, such as where an advertiser 410 is a retailer, and/or may be gathered, stored, and/or recorded indirectly by the advertiser 410, such as where an advertiser 410 has a partnership with a retailer. Though not shown, some systems may additionally or alternatively include or interact with a supplier relations management system, which may be a similar system that may relate to a user's interactions and/or transactions with a supplier.

The CRM system 610 may process, analyze, score, interpret, and/or otherwise determine one or more characteristics about one or more users 310, such as using the stored advertiser information 520. The CRM system 610 may output, transmit, inform, and/or make accessible to the online provider 330 one or more sets, lists, and/or groups of users and/or user identifiers, which may or may not be grouped by one or more characteristics of a user 310. For example, the CRM system 610 may send one or more lists of users, identified by an IP address or user log-in, which may each be determined to have, or be likely to have, a common given characteristic. The classification structure, grouping, and/or characteristics may be identified by the CRM system 610. Alternative or additionally, part or all of the classification structure, grouping, and/or characteristics may be identified or specified in advance by an online provider 330, such as where an online provider 330 may be requesting a group of users 310 which may have certain characteristics, such as those most likely to be responsive to advertisements. Various other examples are possible.

In some systems, the CRM system 610 may output a set or list of advertisement users 615. The list of advertisement users 615 may, for example, include those users 310 that the advertiser 410 and/or CRM system 610 may determine to be likely to pay full price for an item and/or who may be determined to be likely to be responsive to advertisements. For example, users who shop frequently, buy in large quantities, and pay on average a high percentage of a suggested manufacturer's retail price per purchase may be included in the list of advertisement users 615, as it may be determined that such users 310 may be more likely to respond to an advertisement than other users 310 who shop less often, buy in smaller quantities, or pay a lower percentage of a suggested manufacturer's retail price per purchase. Such determinations may be made using, for example, comparisons with historical data, comparisons with other users 310, algorithms, and/or in various other manners. The list of advertisement users 615 may be a set of users 310 whom the CRM system 610 may be identifying to the online provider 330 in order for the online provider 330 to provide or consider to provide these advertisement users 615 with advertisements during a subsequent user interaction with the online provider 330.

The CRM system 610 may output a set or list of promotions users 620. The list of promotions users 620 may include those users 310 that the advertiser 410 and/or CRM system 610 may determine to be likely to pay less than full price for an item, who generally only make purchases when the item is on sale or using a coupon, and/or who may be determined to be likely to be responsive to promotions. For example, users who shop frequently, buy in medium quantities, and pay on low a high percentage of a suggested manufacturer's retail price per purchase and/or uses coupons or other promotional deals may be included in the list of promotions users 620, as it may be determined that such users 310 may be more likely to respond to an promotion than other users 310. Such determinations may be made using, for example, comparisons with historical data, comparisons with other users 310, algorithms, and/or in various other manners. The list of promotions users 620 may be a set of users 310 whom the CRM system 610 may be identifying to the online provider 330 in order for the online provider 330 to provide or consider to provide these promotions users 620 with promotions during a subsequent user interaction with the online provider 330.

The CRM system 610 may output, make accessible, send, and/or otherwise transmit one or more sets, lists, and/or groups of users and/or user identifiers to the online provider 330 periodically or continuously. In some systems, the CRM system 610 may only send raw data and/or processed data to the online provider 330, which may then process this data and/or information about a user's interactions with an advertiser 410 using a classifier model 230 associated with the online provider 330. In some systems, the CRM system 610 may only send updates to the sets, lists, and/or groups, or may send updates and new sets, lists, and/or groups at various times. Various other interactions are possible.

The online provider 330 may use the sets, lists, and/or groups provided by the CRM system 610, such as the list of advertisement users 615 and/or the list of promotions users 620, to determine whether a user that interacts with the online provider 330 should be served with an advertisement or promotion. In some systems, the online provider 330 may include a classifier model 230, which the online provider 330 may use to make a final determination on what users to send an advertisement or promotion to, or whether to send an advertisement or promotion to a given user. Such classifier models 230 may receive, as inputs, the lists of advertisement users 615, lists of promotions users 620, any other determination information from the CRM system 610, internal information 510 collected by the provider (provider information), and/or various other information. The classifier model 230 may analyze this information and make a final determination on what users to send an advertisement or promotion to, or whether to send an advertisement or promotion to a given user.

A determination like this may be conducted each time a user interacts with the online provider 330, may be conducted periodically, and/or may be conducted under certain circumstances, such as when a user no longer appears on a given set, list, and/or group. Other variations are possible.

When an advertising opportunity exists, the online provider 330 may wish to serve an advertisement or promotion. The advertising opportunity may, for example, match one or more characteristics of an advertising campaign. As such, the online provider 330 may identify the advertising campaign that is to use and/or otherwise occupy the advertising opportunity. In some circumstances, the online provider 330 may need to identify whether or not the advertising opportunity will be filled and/or used with an advertisement or a promotion. This may be done, for example, by consulting information and/or data provided by the advertiser 410, such as during the creation of the advertising campaign, and/or may be determined by the online provider 330, such as using and/or analyzing goals of the advertising campaign provided by the advertiser 410. Other variations are possible.

Where an advertisement may be presented for the advertising opportunity, the online provider 330 may, at block 625, show, provide and/or present the advertisement to one or more of the users from the set of advertisement users 615. Alternatively, where a promotion may be presented for the advertising opportunity, the online provider 330 may, at block 630, show, provide, and/or present the promotion to one or more of the users from the set of promotions users 620. This process may or may not be completed every time an advertising opportunity arises, and/or may occur hundreds, thousands, or millions of times minute in some systems.

A user response to the served advertisement may be identified and/or recorded in block 635. A user response to the served promotion may be identified and/or recorded in block 640. Responses may, for example, be a click on the advertisement or promotion, a transaction conducted, a close-box click, and/or no interaction. The user responses identified in blocks 635 and 640 may be sent to the CRM system 610.

The information and/or data about the identified user responses from blocks 635 and 640 may be collected by the CRM system 610. This information and/or data may represent user data 550, such as internal information 510, online ad-clicks information 516, and/or online conversion information 518. The information and/or data collected from the identified user responses from blocks 635 and 640 may be used by the CRM system 610 to augment, further identify, support, and/or contradict scores, analysis, predictions, lists, data, and/or groups identified and/or made by the CRM system 610. For example, in some systems, the CRM system 610 may use the information about user responses to advertisements and promotions to make changes to the lists of advertisement users 615 and promotions users 620. Information and/or data from blocks 635 and 640 may be identified, collected, and/or analyzed periodically and/or continuously.

The flow diagram of FIG. 6 may be performed periodically and/or continuously. The flow diagram may provide for a periodic and/or continuous feedback loop to the CRM system 610, which may allow for periodic and/or constant tweaking and reevaluation of the categorization, propensity, and/or predictions related to one or more users 310.

While FIG. 6 shows the CRM system 610 as being distinct from the online provider 330, in some systems, the online provider 330 may include and/or incorporate part or all of the CRM system 610. Other variations are possible.

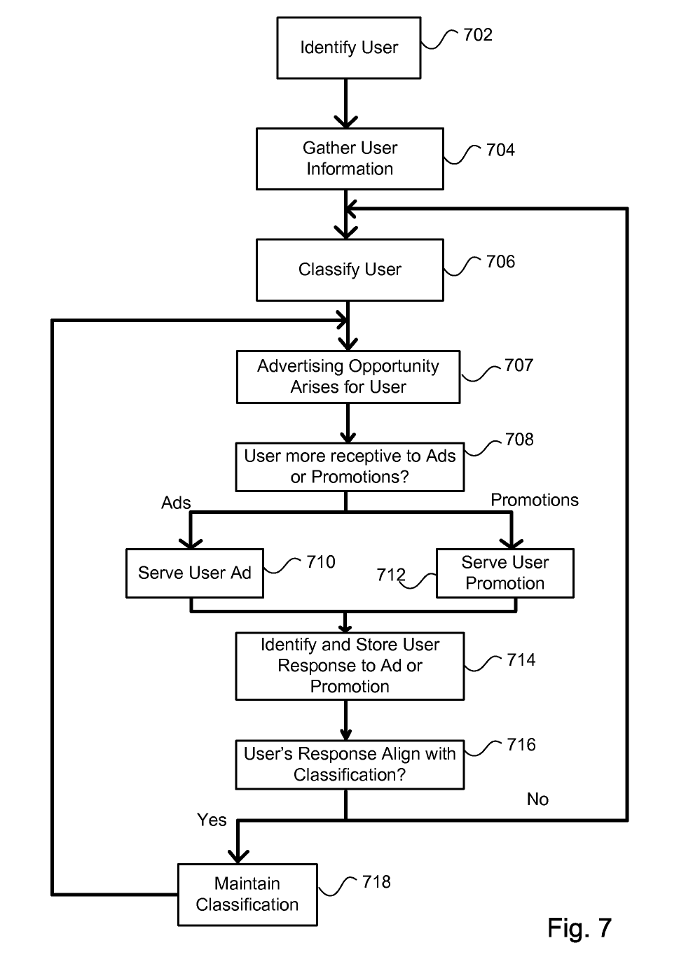

FIG. 7 illustrates an example of a method of using a marketing system, such as the advertising system 140, and/or an online provider 330, for marketing and/or to identify and serve advertisements and/or promotions to one or more users 310. The method of FIG. 7 may begin at block 702, where a user 310 is identified. This may be done, for example, when a user 310 logs onto a web page or module provided by the online provider 330, such as an email account or fantasy sports account. In other examples, this may be done when a user 310 uses a search engine provided by the online provider 330 and/or accesses content from or provided by the online provider 330, such as an article or other media content. The user 310 may be identified using various information and/or data, such as the user's log-in information, email address, IP address, cookie information, and/or various other data and/or information. The user 310 may, for example, be identified through information received by an advertising system 140 through the network interface 240, or in various other ways.

At block 704, information may be gathered about the user 704. This may be information such as the user data 550 previously discussed, information such as information and/or data stored about the user in the user profile database 220, and/or various other information and/or data. In some systems, this information and/or data may be collected and/or stored every time a user 310 interacts with the online provider 330.

At block 706, the user may be classified. For example, user data 550 may be sent to a classifier model 230 of an advertising system 140, such as an advertising system 140 operated and/or used by the online provider 330. The classifier model 230 may classify the user 310, such as by labeling the user 310 an advertisement user or a promotions user. This classification may be based, for example, on processing, analysis, and/or other determinations made by the classifier model 230. In other systems, the classifier model 230 may merely rank, score, designate, and/or otherwise specify the user 310 as falling alone one or more spectrum, such as along a frequency of purchase spectrum, a number of purchases spectrum, and/or an average price compared to a retail price spectrum.

At block 707, an advertisement opportunity may arise related to an interaction of the user 310 with the advertising system 140 and/or online provider 330. While block 707 is shown as occurring after a classification of the user and before a determination of whether to serve the user with an advertisement or a promotion, it should be noted that the user may be classified and/or it may be determined whether to serve the user with an advertisement or promotion after and/or contemporaneously with an identification of an advertising opportunity.

At block 708, the advertising system 140 and/or online provider 330 may determine whether the user 310 may be more receptive to advertisements or to promotions. In some systems, this determination may be made by determining the classification of the user 310 provided from the classifier model 230. For example, where the classifier model 230 identifies the user 310 on a set of advertisement users 615, the user 310 may be determined to be more receptive to advertisements. In other systems, the rankings, scores, designations, and/or specifications provided by the classifier model 230 may be interpreted and/or analyzed, such as against historical models and/or using algorithms, to determine whether a user may be more receptive to advertisements or promotions. In some systems, an expected or other profitability of advertisements served to the user 310 may be compared to an expected or other profitability of promotions served to the user 310, and the higher expected profitability may determine whether an advertisement or promotion may be served. Other variations are possible.

Where the user is more receptive to advertisements, the method may proceed to block 710, where the user may be served an advertisement. Where the user is more receptive to promotions, the method may proceed to block 712, where the user may be served with a promotion. Where other categories exist, the determination in block 708 may be result in other steps, such as serving a user with different information based on the user's expected propensity and/or receptiveness to the information to be provided.

After blocks 710 and 712, the method may proceed to block 714. The user's response to the advertisement served in block 710, or the user's response to the promotion served in block 712, may be identified and stored. The responses may, for example, be a click on the advertisement or promotion, a transaction conducted, a close-box click, and/or no interaction. Various other responses are possible. The responses may represent user data 550 and/or user profile information such as information or data stored in the user profile database 220. Information and/or data about the responses may be stored, such as in the user profile database 220, the data store 145, and/or various other places.

At block 716, the advertising system 140 and/or online provider 330 may determine whether or not the user's response aligns with the classification identified in block 706. In some systems, the advertising system 140, classifier model 230, and/or online provider 330 may compare the user's response identified in block 714 with a response expected and/or predicted, such as by the user's classification.

When the user's response conforms and/or aligns with the predicted response, the method may proceed to block 718, where the classification from block 706 may be maintained. For example, a user 310 who engages in frequent transactions using coupons or promotions may be expected to respond to a shown promotion by clicking on or engaging in a transaction based on a promotion served. When the user 310 clicks on a promotion served, the advertising system 140 may assume that the promotion was effective, and the user's response may align with the predicted response.

If the classification is maintained in block 718, the method may proceed back to block 707. When another advertisement opportunity arises for the user 310, the user may be served an advertisement based on the classification of the user previously determined. The process may then continue as described above.

If at block 716, the user's response does not align and/or conform with the classification, the advertising system 140 may wish to re-classify and/or re-evaluate the user 310. In these circumstances, the method may proceed back to block 706, and the user may be classified again. From there, the method may proceed as described. In some systems, a determination that a user's response does not conform or align with an expected response may not be done after one response, but may require a certain number of non-conforming or non-aligning responses before triggering the re-classification and/or re-evaluation of the user 310.

While the method of FIG. 7 shows a determination in block 716 of the user's response as compared to an expected response, in some systems, the user 310 may be continuously reclassified and/or re-evaluated each time that an advertising opportunity arises. For example, data about the user's response may be fed into the CRM system 610 and/or a classifier model 230, which may constantly and/or periodically update the online provider 330 with a classification and/or identification of characteristics of the user 310. In some of these systems, the advertising system 140 may take the most recent update received, at any given time, and use that updated classification and/or identification to serve a user 310 with an advertisement or promotion when the advertising opportunity arises.

Information and/or data about the user 310 may be used, analyzed, and/or processed to resolve, at the time of serving an advertisement or a promotion, to determine whether or not the user 310 would benefit from a promotion or an advertisement. Other variations are possible.

The advertising system 140 may be used, for example, on an advertising opportunity by advertising opportunity basis. For example, each time that a user 310 creates an advertising opportunity, such as by viewing content provided by the online provider, the advertising system 140 may identify whether or not to serve the user 310 with an advertisement or a promotion.

The advertising system 140 may also be used, for example, to manage an advertising campaign. For example, an advertising system 140 may manage and/or operate an advertising campaign to ensure that a specified and/or requested number of impressions or views of an advertisement and/or promotion may be delivered, and/or may ensure that the specified and/or requested number of impressions or views of an advertisement and/or promotion are delivered in an efficient and productive manner, such as by targeting users 310 to receive the advertisements and/or promotions.

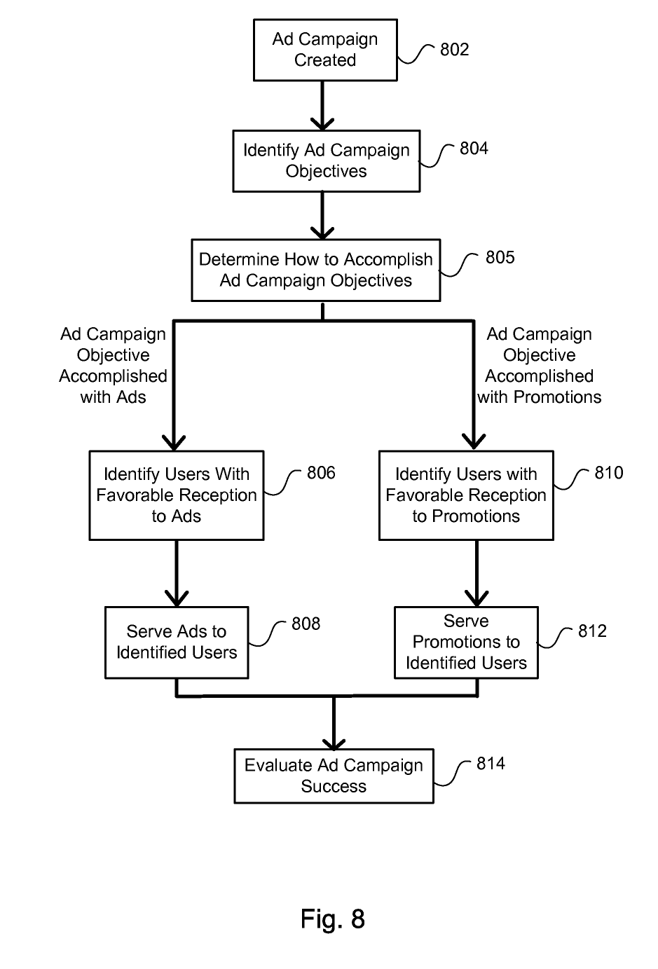

FIG. 8 illustrates an example of a method of using a marketing system, such as the advertising system 140, and/or an online provider 330, for marketing and/or to create, manage, and/or run an advertising campaign. At block 802, an ad campaign may be created. The ad campaign may include one or more advertisements and/or promotions. The ad campaign may include information about the advertiser's goals and/or objectives. The ad campaign may include information such as a budget, number of plays or views, and/or various other information and/or data. In some systems, the advertiser 410 may merely provide a budget and one or more details about the advertiser 410, and the online provider 330 may be tasked with and/or left to optimize the online marketing efforts of the advertiser 410. The online provider 330 in these systems may identify a number of advertising opportunities, identify whether the user associated with the advertising opportunities is more receptive to an advertisement or a promotion, and may serve an advertisement and/or promotion accordingly. Ad campaign may, for example, be stored in the advertising campaign database 210 of the advertising system 140, or in various other locations.

At block 804, one or more ad campaign objectives may be identified. In some systems, the advertiser 410 may specify an ad campaign objective. The ad campaign objective may capture or otherwise identify an advertiser's success criteria for the advertising campaign. In some cases, the ad campaign objective may be to run an advertisement or a promotion a specified number of times, and/or over a specified time frame, and/or to a specified type of user. For example, the advertiser 410 may specify that the advertiser 410 wishes to run an advertisement for a given period of time with a given number of impressions guaranteed each day. In this example, the ad campaign objective is best served by running the advertisement as requested. In other examples, the advertiser 410 may have and/or specify multiple ad campaign objectives, such as by request that three different advertisements each be run a given number of times over a specified time period, as well as requesting that two promotions be run over another time frame a specified number of times. Other variations are possible.

In other systems, an online provider 330 may have and/or use a campaign optimizer or other campaign optimization component to determine an advertising campaign objective and/or how to best accomplish the advertising campaign objective. A campaign optimizer may be useful, such as where the advertiser 410 may request and/or specify the ad campaign objectives without clearly identifying how to fulfill the objectives. The campaign optimizer may consider, analyze, and/or watch over one or more constraints, criteria, and/or factors of one or more advertising campaign. For example, the campaign optimizer may consider, analyze, and/or watch over an advertising campaign budget, profitability targets, proportional exposure in various sub-targets, and various other criteria. The campaign optimizer may be used for maximizing, or attempting to maximize, advertising campaign objectives, such as by varying any tunable parameters like a bid adjustments, budget release rates, targeting, and/or various other parameters of the advertising campaign. The campaign optimizer may try to extract as much value from an advertising campaign as can be achieved. The element of promotion versus advertisement may provide an additional or alternative set of tunable parameters for the campaign to be optimized, which may extend and improve the performance of the advertising campaign.

The advertising system 140 and/or campaign optimizer may receive information from the advertiser 410, which the advertising system 140 and/or campaign optimizer may analyze, process, compute, and/or interpret to determine a best way to accomplish the ad campaign objectives of the advertiser 410. For example, an advertiser 410 may specify that the advertiser 410 wishes to clear out an old inventory, or to promote a fresh or new line of products. In some ad campaigns, multiple objectives may be identified and/or used. For example, an ad campaign may wish to clear out old inventory to make room for a new line of products, and may wish to advertise for the new line at the same time. Various other examples are possible.

At block 805, the advertising system 140 and/or campaign optimizer may determine how to accomplish the ad campaign objectives. In some systems, the advertising system 140 and/or campaign optimizer may determine whether a promotional response is more profitable or otherwise worth more to an advertiser 410 than a general lift or increase in brand awareness that may be gained from showing an advertisement. In situations where the ad campaign objective in block 804 is to run an advertisement and/or promotion according to parameters set by the advertiser 410, the method of accomplishing the ad campaign objective may be to run the identified advertisement and/or promotion according to parameters set by the advertiser 410. In situations where the ad campaign objective identified in block 804 does not clearly identify a method of how to accomplish the ad campaign objective, the advertising system 140 and/or campaign optimizer may determine how best to accomplish the ad campaign objective identified in block 804.

For example, in systems where an advertiser 410 indicates a desire to clear out an old inventory, the advertising system 140 and/or campaign optimizer may identify and/or determine that this ad campaign objective may be best served with promotions and/or coupons. Where an advertiser 410 indicates a desire to promote a fresh or new line of products, the advertising system 140 and/or campaign optimizer may identify and/or determine that this ad campaign objective may be best served with advertisements and/or brand awareness campaigns. This identification and/or determination may be made using, for example, historical data and trends, algorithms, analysis of previous ad campaigns, modeling, and/or various other techniques.

Where an ad campaign objective is identified which may be accomplished with advertisements, the method may move to block 806, where users with favorable reception to advertisements are identified. In some systems, the classifier model 230 may continuously and/or periodically classify one, more than one, or all users into two or more sets of users, such as a set of users likely to be responsive to ads, and a set of users likely to be responsive to promotions. In other systems, an online provider 330 may wait until the demand exists for users with favorable reception to advertisements before identifying such users at block 806.

In either case, once the users with favorable reception to advertisements are identified, the method may move to block 808, where an advertisement may be served to one or more of the identified users from 808. The number of users served with the advertisement may depend on a supply of advertisement opportunities, limits imposed by the online provider 330, and/or parameters specified by the advertiser 410, such as a budget and/or limit specified by the advertiser 410.

Where an ad campaign objective is identified which may be accomplished with promotions, the method may move to block 810, where users with favorable reception to promotions are identified. In some systems, the classifier model 230 may continuously and/or periodically classify one, more than one, or all users into two or more sets of users, such as a set of users likely to be responsive to ads, and a set of users likely to be responsive to promotions. In other systems, an online provider 330 may wait until the demand exists for users with favorable reception to promotions before identifying such users at block 810.

In either case, once the users with favorable reception to promotions are identified, the method may move to block 812, where a promotion may be served to one or more of the identified users from block 812. The number of users served with the promotion may depend on a supply of advertisement opportunities, limits imposed by the online provider 330, and/or parameters specified by the advertiser 410, such as a budget and/or limit specified by the advertiser 410.

In some systems, blocks 806, 808, 810, and/or 812 may be repeated numerous times and/or over a period of time, with numerous advertisements and/or promotions being served to identified users. In some systems, these blocks may be repeated up to and/or until a limit of the online provider 330 and/or parameters specified by the advertiser 410 are met. In some systems, data about one or more of the responses of users to the advertisements and/or promotions are recorded and/or stored.

After blocks 808 and 812, the method may proceed to block 814, where the success of the ad campaign may be evaluated. This may include reviewing data and/or information about a sales and/or success of the ad campaign, advertisements, and/or promotions served as compared with expected results and/or results for other ad campaigns. The information and/or data collected from user responses may be compared, for example, to historical data and trends, models, using algorithms, a control group of users who may have been treated and shown various messages, and/or in various other manners. Using this information and/or data, the success of the ad campaign may be compared and/or analyzed to determine whether or not the ad campaign is as successful as expected or not.

The cause of unexpected results, such as a misclassification of users or a problem with one or more models used to classify users, such as the classifier model 230, may be determined. Changes to the classification of users and/or the classifier model 230 may be made as a result of the evaluation. An evaluation of the ad campaign may thus allow the online provider 330 to evaluate one or more user 310 classifications. In some circumstances, the users 310 may be misclassified because the user 310 may have habits which may have changed, such as based on income and/or ages. Various other examples are possible.

While shown as taking place at the end of the method, in some circumstances, the evaluation may take place before the ad campaign ends. For example, an evaluation of the ad campaign may take place at predetermined intervals, such as every three months. In other examples, an evaluation of the ad campaign may take place when certain limits are surpassed or certain expectations are not achieved, such as when a ratio of views to click-throughs is above or below an expected threshold. In such circumstances, the method may return to just before or just after block 804, and the method may continue in a continuous loop throughout the remainder of the ad campaign. Other variations are possible.

In another method, a user may present a network or online provider 330 with an opportunity to show something, such as an advertisement or a promotion, in an advertising space. This may be an advertising opportunity. The network and/or online provider 330 may determine one or more advertising campaigns which may be vying for the user and/or interested in advertising to the user. The campaigns may have one or more advertisements or promotions. In some systems, one or more advertising campaigns may specify a type of user that the associated advertisers 410 may be interested in serving an advertisement or promotion to. Those advertising campaigns with criteria which may partially or completely match the user or advertising opportunity may be considered and/or analyzed by the system. For example, an advertiser 410 may only wish to present advertisements or promotions to a user viewing sports content, or to a user who is a registered member of a certain club. The advertising campaign of these advertisers may only be considered when users meeting these criteria present advertising opportunities.

For each campaign-user pair, the advertising system 140, the online provider 330, and/or the classifier model 230 may compute or determine a utility of showing a promotion or advertisement to the user. In some systems, this may be done for each advertisement and promotion in each advertising campaign which matches the criteria of the user. In other systems, other variations are possible. The utility computed and/or determined may include or factor in revenue that the advertiser 410 and/or the online provider 330 may earn from showing the promotion or advertisement, a level of fulfillment of the advertiser's campaign objective, and/or various other aspects such as not spoiling a high margin user by using a promotion. The network or online provider 330 may pick the advertising campaign which has the highest utility or which is associated with an advertisement or promotion that has the highest utility, and may serve the advertisement or promotion for that advertising campaign. Various other methods are possible.

While the above described methods and systems may refer to a comparison and/or determination as to whether one element is greater than or equal to a second element, in some embodiments one or more of these comparisons may be replaced by a comparison and/or determination as to whether one element is greater than a second element. Similarly, comparisons and/or determinations described as being “greater than” may also be replaced with “greater than or equal to.” While the above described methods may refer to a comparison and/or determination as to whether one element is less than or equal to a second element, in some embodiments one or more of these comparisons may be replaced by a comparison and/or determination as to whether one element is less than a second element. Similarly, comparisons and/or determinations described as being “less than” may also be replaced with “less than or equal to.” Comparisons and/or determinations made which require an element to “exceed” a second element may be replaced by comparisons and/or determinations which require an element to “exceed or equal” a second element, and vice versa.

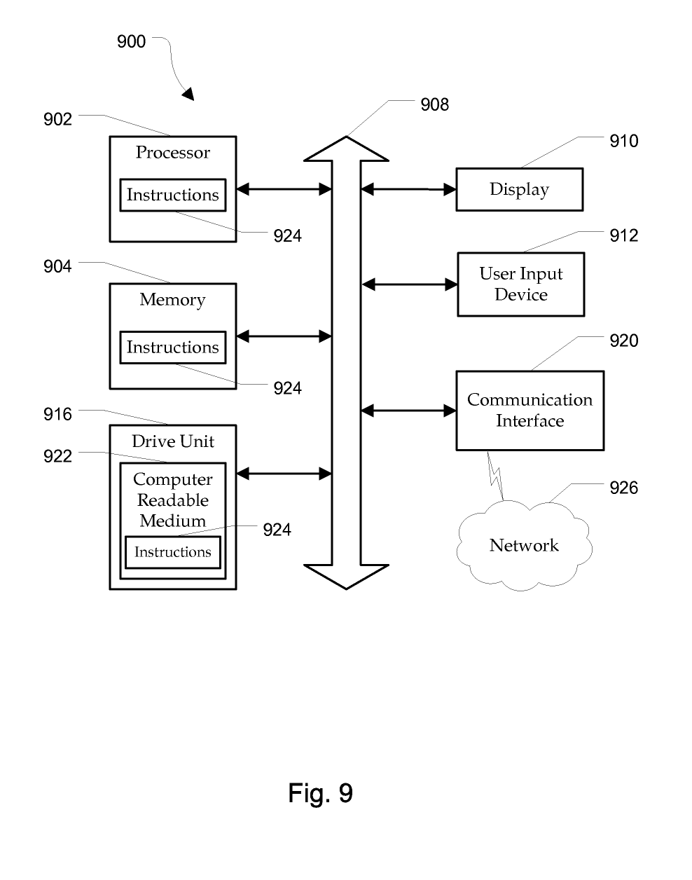

The advertisement system 140, client applications 115, 125A-125N, and/or online providers 330 may be or include part or all of one or more computing devices of various kinds, such as the computing device in FIG. 9. FIG. 9 illustrates an embodiment of a general computer system designated 900. Various components from the described systems, such as the web application 125A, the standalone applications 115, 125B, the mobile application 125N, the advertising system 140, the advertising campaign database 210, the user profile database 220, the classifier model 230, the campaign optimizer, and/or the network interface 240, may be or include part or all of the computer system 900.

The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 may be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 904 includes a cache or random access memory for the processor 902. In alternative embodiments, the memory 904 may be separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 may be operable to store instructions executable by the processor 902. The functions, acts or tasks illustrated in the figures or described herein may be performed by the programmed processor 902 executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 910, such as a liquid crystal display (LCD), an organic light emitting diode (OLED), a flat panel display, a solid state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 916.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the computer system 900.

In a particular embodiment, as depicted in FIG. 10, the computer system 900 may also include a disk or optical drive unit 916. The disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the memory 904 and/or within the processor 902 during execution by the computer system 900. The memory 904 and the processor 902 also may include computer-readable media as discussed above.

A computer-readable medium may include instructions 924 and/or receive and execute instructions 924 responsive to a propagated signal so that a device connected to a network 926 can communicate voice, video, audio, images or any other data over the network 926. Further, the instructions 924 may be transmitted or received over the network 926 via a communication port or interface 920, and/or using a bus 908. The communication port or interface 920 may be a part of the processor 902 or may be a separate component. The communication port 920 may be created in software or may be a physical connection in hardware. The communication port 920 may be configured to connect with a network 926, external media, the display 910, or any other components in system 900, or combinations thereof. The connection with the network 926 may be a physical connection, such as a wired Ethernet connection or may be established wirelessly as discussed below. Likewise, the additional connections with other components of the system 900 may be physical connections or may be established wirelessly. The network 926 may alternatively be directly connected to the bus 908.

The network 926 may include wired networks, wireless networks, or combinations thereof. The wireless network may be a cellular telephone network, an 802.11, 802.16, 802.20, or WiMax network. Further, the network 926 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The systems and methods described may provide many advantages. For example, by serving a user 310 with material, such as advertisements or promotions, which the user may be more receptive to, the advertising system 140 may be able to increase efficiency and/or returns on advertising campaigns for advertisers 410. This may increase brand awareness and/or sales for parties interacting with an online provider 330. In addition, an online provider 330 may be able to incorporate and/or use more information that that information just gathered by the online provider 330, such as information gathered by the advertisers 410 and/or third parties 420. The use of information external to the online provider 330 may provide a broader and deeper understanding of a user 310 and may assist and/or determine how to best serve a user with advertisements or promotions. Additionally, the advertising system 140 may be used to determine how to most effectively implement an advertising campaign for an advertiser 410, without requiring that the advertiser 410 specify where money and/or resources are to be applied. In this way, the advertiser's budget and/or resources are best allocated, such as by serving advertisements to those users receptive to advertisements, and by serving promotions to those users receptive to promotions. Various other advantages are possible.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer-implemented method of marketing, comprising:
identifying an opportunity to serve an advertisement or promotion to a user;
gathering information about the user;
computing, through the use of at least one processor, an expected responsiveness of the user to advertisements based on the gathered information;
computing, through the use of the at least one processor, an expected responsiveness of the user to promotions based on the gathered information; and
providing the advertisement or the promotion to the user based on the determined expected responsiveness of the user to advertisements and the determined expected responsiveness of the user to promotions.

2. The method of claim 1, wherein gathering information about the user comprises gathering information about the user from both an online provider and from an advertiser.

3. The method of claim 2, wherein the information gathered from an advertiser includes online and offline information about a user.

4. The method of claim 1, wherein gathering information about the user comprises gathering commercial and non-commercial information about the user.

5. The method of claim 1, further comprising:
classifying the user as an advertisements user or a promotions user based on the computed expected responsiveness of the user to advertisements and the computed expected responsiveness of the user to promotions;
wherein the user is provided with the advertisement when the user is classified as an advertisement user; and
wherein the user is provided with the promotion when the user is classified as a promotions user.

6. The method of claim 5, further comprising:
determining if a response of the user to the served advertisement or promotion conforms with the classification of the user;
maintaining the classification of the user when the response conforms with the classification of the user; and
re-classifying the user when the response does not conform with the classification of the user.

7. The method of claim 1, further comprising:
computing a utility of serving an advertisement to the user, wherein the utility of serving the advertisement to the user is computed based on an expected revenue from serving the advertisement to the user and a level of fulfillment of an advertising objective for an advertiser associated with the advertisement;
computing a utility of serving a promotion to the user, wherein the utility of serving the promotion to the user is computed based on an expected revenue from serving the promotion to the user and a level of fulfillment of an advertising objective for an advertiser associated with the promotion;
wherein the user is provided with the advertisement when the utility of serving the advertisement is greater than the utility of serving the promotion; and
wherein the user is provided with the promotion when the utility of serving the promotion is greater than the utility of serving the advertisement.

8. A computer-implemented method of marketing, comprising:
generating, through the use of at least one processor, an advertising campaign with an online provider, where the advertising campaign is for an advertiser and includes an advertisement and a promotion;
gathering, through the use of the at least one processor, provider information about a user, the provider information including information about a user's interactions with the online provider;
receiving advertiser information about the user, the advertiser information including information about the user's interactions with the advertiser;
determining, through the use of the at least one processor, whether it is more profitable to serve the advertisement or the promotion to the user, the determination based on the provider information and the advertiser information; and
serving the advertisement or the promotion to the user based on the determination.

9. The method of claim 8, where the provider information includes information about an online search conducted by the user with the online provider.

10. The method of claim 8, where the provider information includes information about an ad-click or conversion by the user with the online provider.

11. The method of claim 8, where the advertiser information includes information about an in-person transaction with the user and the advertiser.

12. The method of claim 8, wherein the advertiser information about the user is received from a third party in communication with the advertiser.

13. The method of claim 12, wherein the advertiser information comprises information from the advertiser about the user that has been filtered by the third party to remove confidential information about the user.

14. The method of claim 12, wherein the received advertiser information includes cookie or log-in information about the user.

15. The method of claim 8, wherein the advertiser information indicates that the user is more receptive to promotions than to advertisements.

16. The method of claim 8, wherein the advertiser information indicates that the user is more receptive to advertisements than to promotions.

17. A marketing system comprising:
a processor;
an advertising campaign database in communication with the processor and configured to store information about an advertising campaign for an advertiser, the advertising campaign including an advertisement, a promotion, and an objective;
a user profile database in communication with the processor, the user profile database configured to store information about a first set of users and a second set of users; and
a campaign optimizer configured to determine if the objective is better accomplished by serving the advertisement or the promotion;
wherein the processor serves the advertisement to the first set of users when the determination indicates that the objective is better accomplished by serving the advertisement; and
wherein the processor serves the promotion to the second set of users when the determination indicates that the objective is better accomplished by serving the promotion.

18. The system of claim 17, wherein the first set of users consists of users that are more responsive to advertisements than to promotions; and
wherein the second set of users consists of users that are more responsive to promotions than to advertisements.

19. The system of claim 18, wherein the first set of users and the second set of users are identified based on information about each of the first set of users and the second set of users gathered by an online provider and information about each of the first set of users and the second set of users received from the advertiser.

20. The system of claim 19, wherein the information about each of the first set of users and the second set of users received from the advertiser includes information about a transaction with the advertiser and the user that did not occur online.

21. The system of claim 20, wherein the transaction was an in-person transaction between the advertiser and the user occurring a place of business of the advertiser.
